(19) United States
(12) Patent Application Publication
(10) Pub. No.: US 2018/0169802 A1
(43) Pub. Date: Jun. 21, 2018

(54) ARTICULATED WELDING BOOM

(71) Applicant: RAKA CORPORATION, Toledo, OH (US)

(72) Inventors: Eric Steffes, Toledo, OH (US); Dennis Vetter, Toledo, OH (US)

(21) Appl. No.: 15/384,454

(22) Filed: Dec. 20, 2016

(51) Int. Cl. B23K 37/02; B65H 49/00; B23K 9/133

(52) U.S. Cl. CPC B23K 37/02; B65H 49/00; B65H 2801/00; B65H 2701/36; B23K 9/133

(57) ABSTRACT

An articulated welding boom is disclosed, the boom having two guide modules above and below the primary swivel joint. The swivel joint itself is insulated from wire used to weld to prevent unwanted arcing. A wire feeder is mounted at an end of the secondary arm. Flexible wire conduit connects the guide module and the wire feeder, and the secondary arm folds down so that the operator can load or unjam the feeder without a ladder or lift.

### FIELD OF THE INVENTION

The field of the invention is welding booms and, more particularly, an articulated welding boom that provides more welding coverage than that of a stationary wire feeder.

### BACKGROUND OF THE INVENTION

Non-articulated boom jibs and bridge cranes have been used in the past to extend welding coverage, however, with those configurations, the wire spool or drum had to travel with the feeder. This caused two problems:

(1) The spool or drum was added weight that the operator had to move around.

(2) Changing out the spool or drum overhead is either dangerous or time consuming.

It would be desirable to develop an articulated welding boom to provide more welding coverage during welding operations.

### SUMMARY OF THE INVENTION

Concordant and congruous with the present invention, an articulated welding boom to provide more welding coverage during welding operations has surprisingly been discovered.

The articulated welding boom is designed to accept a two guide modules above and below the primary swivel joint. The swivel joint itself is insulated from the wire to prevent unwanted arcing. A wire feeder is mounted at the end of the secondary arm. Flexible wire conduit connects the guide module and the wire feeder. Additionally, the secondary arm folds down so that the operator can load or unjam the feeder without a ladder or lift.

According to embodiments of the invention, the shortcomings noted above in the Background are eliminated.

### BRIEF DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is side elevational view of the articulated weld boom with arms extended and also showing a drum of wire;

FIG. 2 is a top elevational view of the articulated weld boom with secondary arms shown at an acute angle;

FIG. 3 is a side elevational view of the articulated weld boom with the secondary arm folded down;

FIG. 4 is a side elevational view of the articulated weld boom having a wire spool;

FIG. 5 is a phantom view of a wire guide module of the articulated weld boom at a primary swivel joint;

FIG. 6 an enlarged view of the secondary arm of the articulated weld boom;

FIG. 7 is a perspective view of the articulated weld boom;

FIG. 8 is a side plan view of three mounting options for the articulated weld boom according to additional embodiments of the invention.

### DETAILED DESCRIPTION OF EXEMPLARY EMBODIMENTS OF THE INVENTION

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

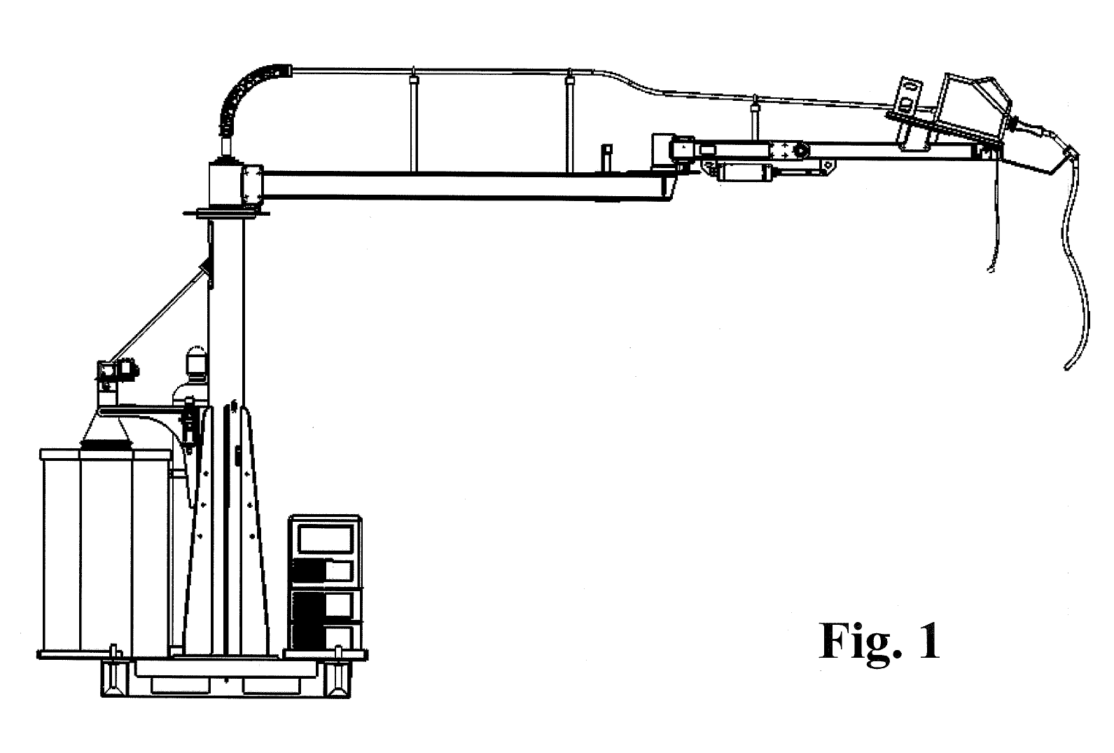

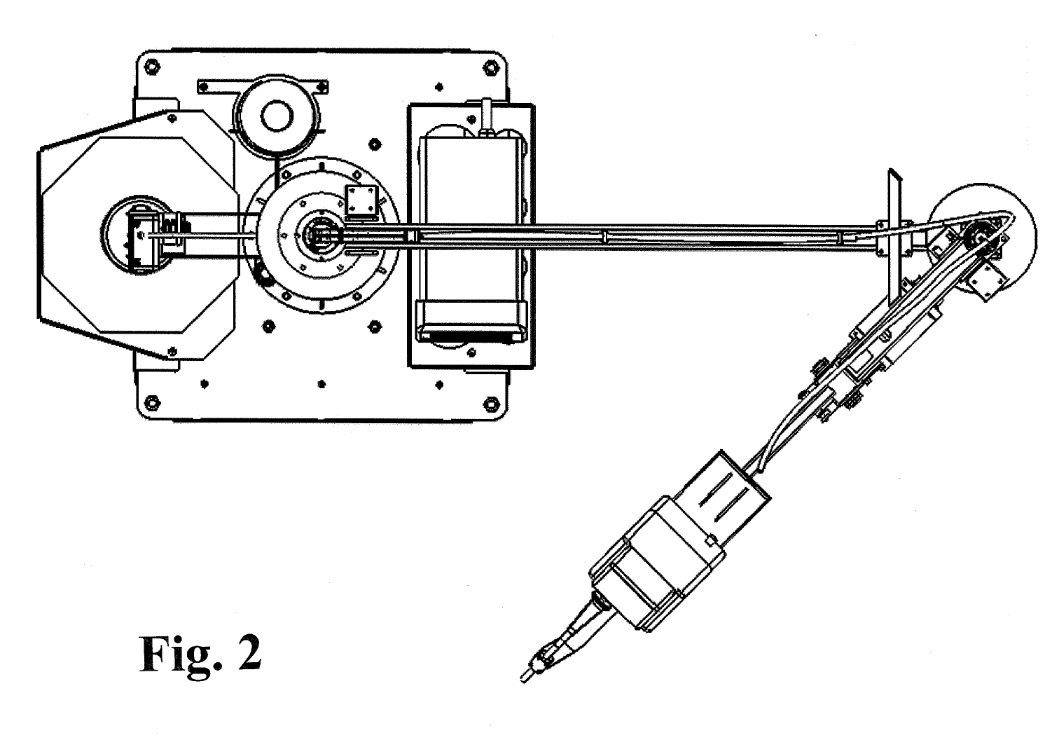

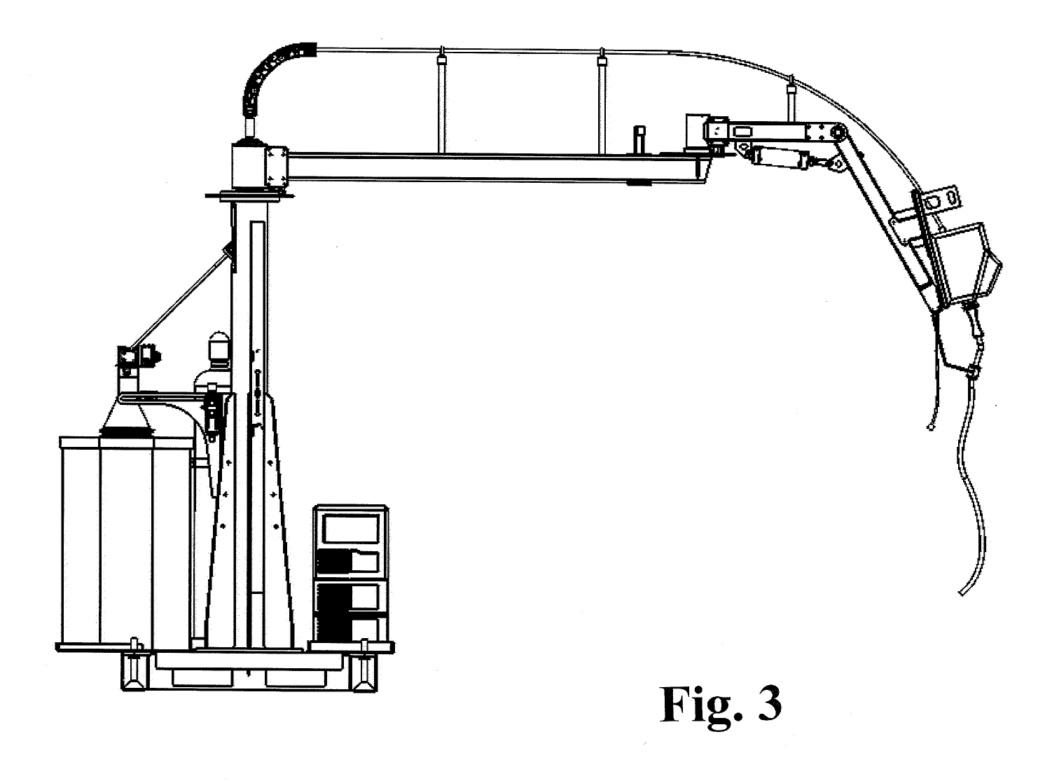

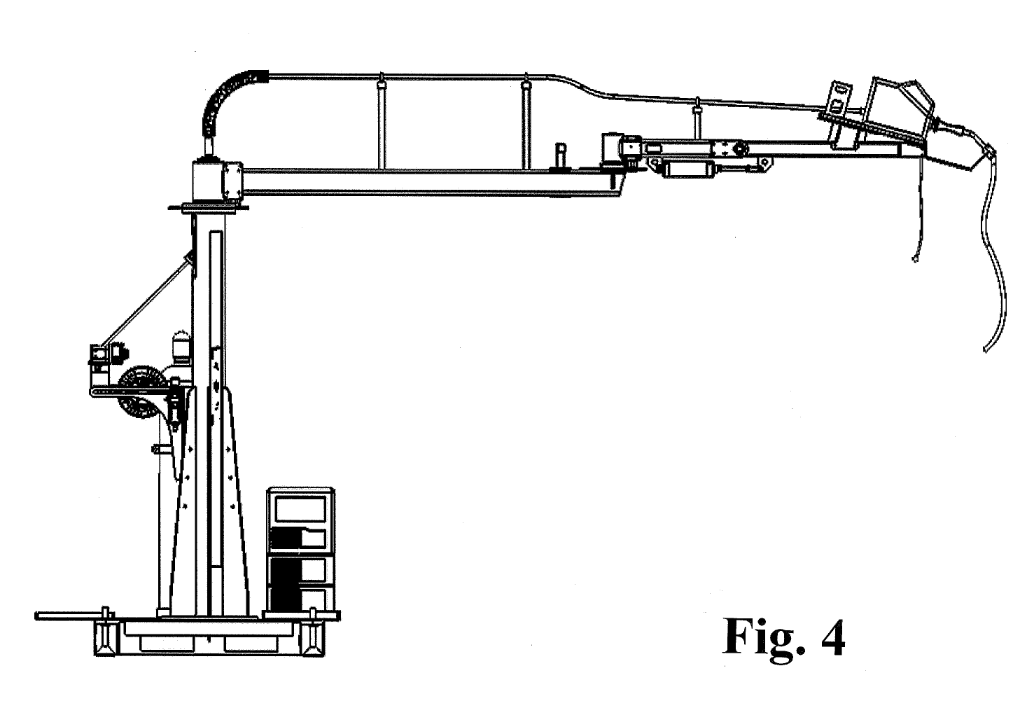

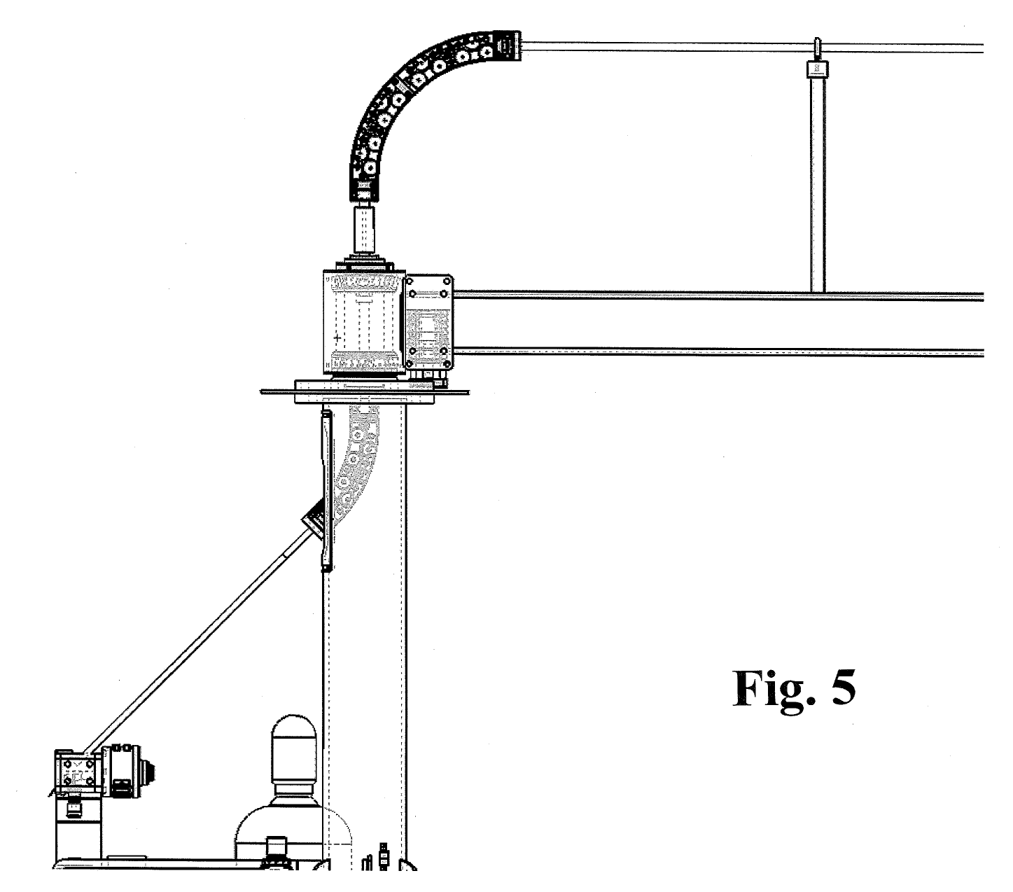

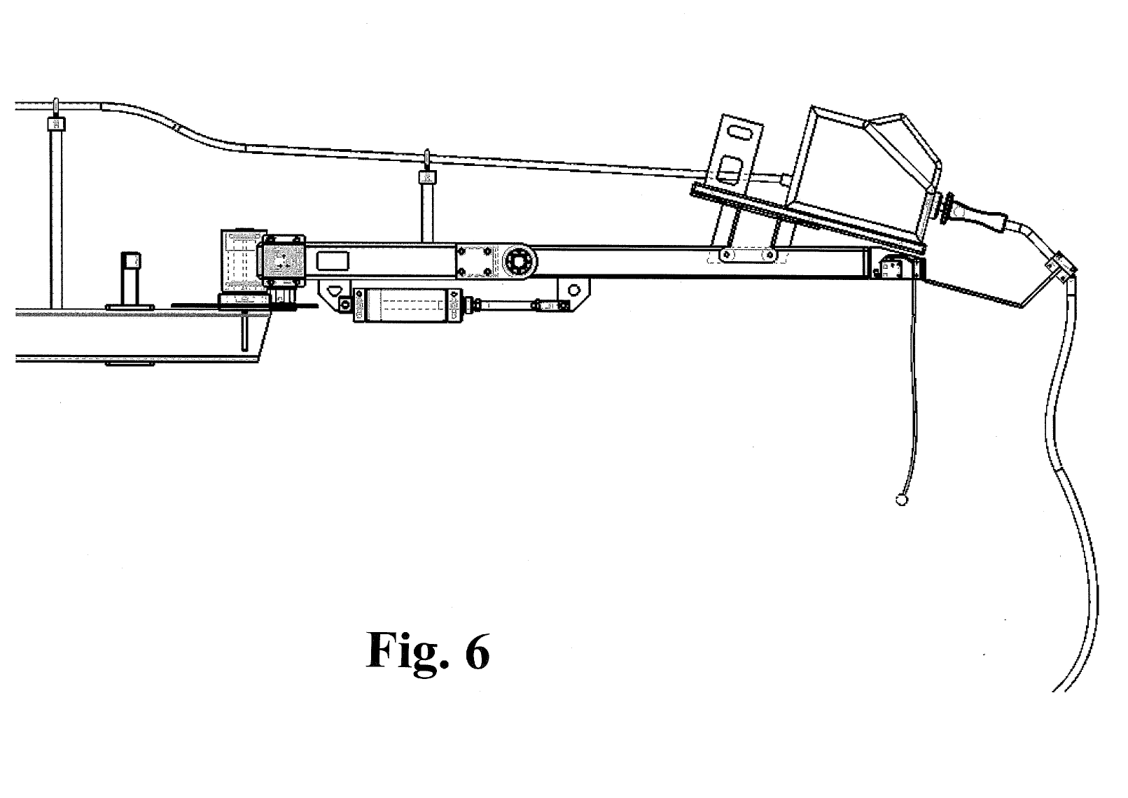

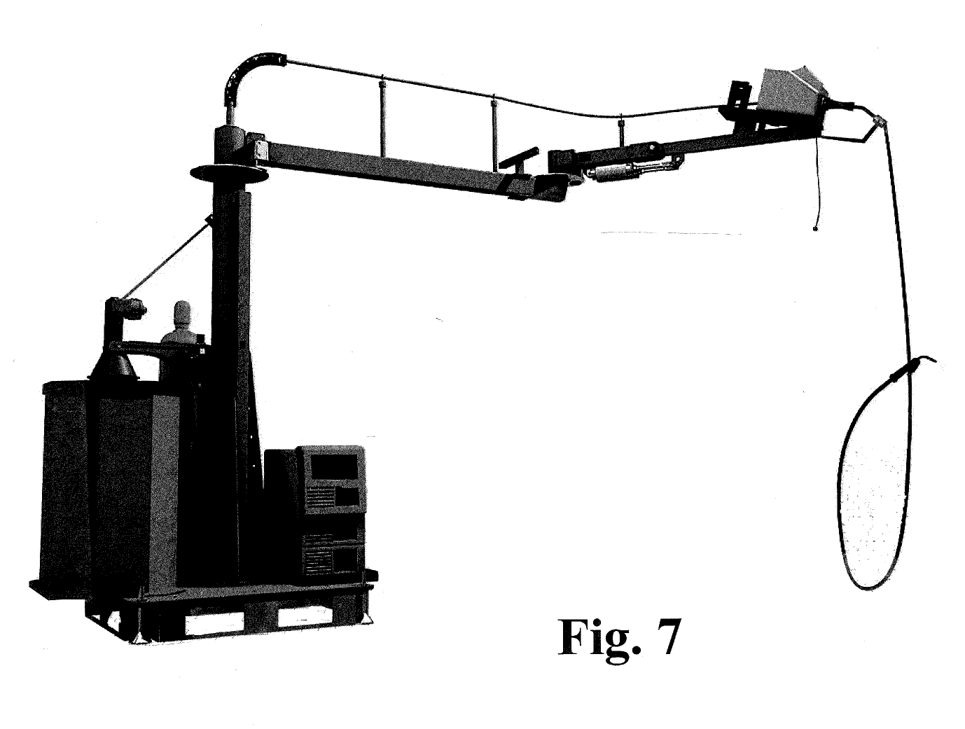

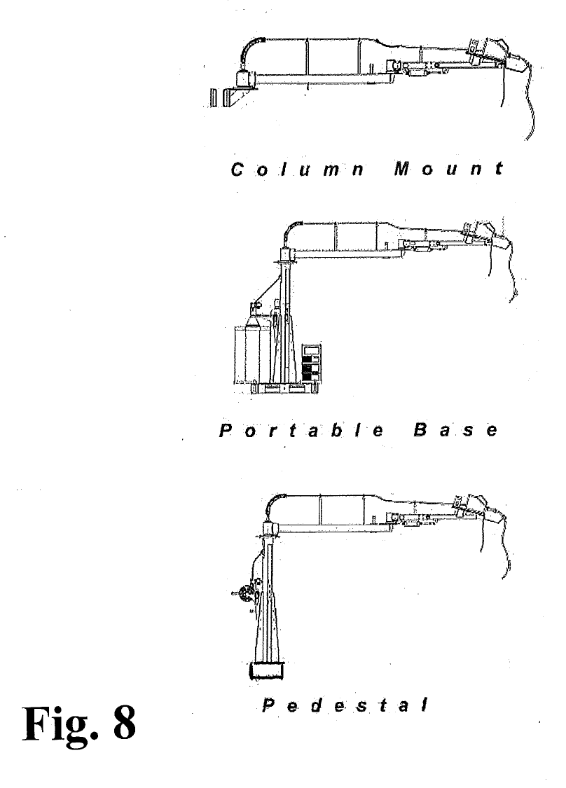

Embodiments of the invention are shown in FIGS. 1-8 and as described hereinbelow. Specifically, the articulated welding boom is designed to accept a two guide modules above and below the primary swivel joint. The swivel joint itself is insulated from the wire to prevent unwanted arcing. A wire feeder is mounted at the end of the secondary arm. Flexible wire conduit connects the guide module and the wire feeder. Additionally, the secondary arm folds down so that the operator can load or unjam the feeder without a ladder or lift. One embodiment of the invention has a 13 foot arm and 15 foot whip for a 26 foot radial reach, though other lengths may be used without departing from the scope of the invention. The whip includes a welding gun on an end thereof (see FIG. 7).

The articulated welding boom incorporates two swivel joints. Each joint is equipped with tapered roller bearings, pre-greased and shielded. These bearing arrangements allow for articulation of the primary and secondary arms of the boom for easier welding.

Portable base option comes with a mount for a wire spool, a tray for a drum of wire, a tray for the welder power supply, a tray & chain clasp for a gas tank, a mount for an air regulator, and a mount for a wire feed-assist.

Optional air brake for each swivel joint is available. The air brakes are controlled with a pneumatic switch suspended on an end of the arm.

High quality wire guide modules allow for virtually zero drag from pedestal inlet to end of arm wire feeder. Furthermore, spools or drums of wire or other materials may be integrated into the boom on the platform of the portable base model (see FIGS. 1-3 and 7). The portable base (See FIG. 7) allows the boom to be moved with a fork truck or other similar device.

Fold down arm feature allows for quick and easy supply and maintenance of weld gear.

Additional features of the invention include increased material pulling capabilities. The boom is capable of feeding, for example, aluminum, even when the arms thereof are angled. A rocker switch is mounted to the system that incrementally tilts and end of an arm of the system upwardly or downwardly allowing a welder to access the feeder.

From the foregoing description, one ordinarily skilled in the art can easily ascertain the essential characteristics of this invention and, without departing from the spirit and scope thereof, can make various changes and modifications to the invention to adapt it to various usages and conditions.

I claim:

1. An articulated weld boom comprising:
a shielded swivel joints each equipped with tapered roller bearings;
a first secondary arm having a wire feeder on an end thereof;
a second secondary arm coupled to the first secondary arm by the swivel joint; and
a portable base capable of being moved by a fork truck upon which the weld boom is mounted, the base including a mount for a wire spool.
